(19) United States
(12) Patent Application Publication
(10) Pub. No.: US 2012/0244343 A1
(43) Pub. Date: Sep. 27, 2012

(54) BONDING STRUCTURAL COMPONENTS FOR PORTABLE ELECTRONIC DEVICES USING THERMALLY ACTIVATED ADHESIVE

(76) Inventor: Kurt Stiehl, San Jose, CA (US)

(21) Appl. No.: 13/072,586

(22) Filed: Mar. 25, 2011

(51) Int. Cl. B32B 17/00; B32B 37/30; B32B 37/12; B32B 37/14; B32B 37/02; B32B 37/06

(52) U.S. Cl. 428/332; 156/275.7; 156/272.8; 156/275.3; 428/426

(57) ABSTRACT

Techniques for optically activating thermally activated adhesives are disclosed. In one embodiment, a laser can be used to activate thermally activated adhesive. In one implementation, a laser output can be directed through a structural component being coupled to another structural component through use of the thermally activated adhesive. As a result, the structural components to be adhered together can, first, be placed in the appropriate position with the adhesive in a non-active state, and second, a laser can provide the laser output to activate the adhesive (whereby the adhesive transitions from the non-active state to an active state).

### BACKGROUND

Conventionally, a portable electronic device has a housing that encases various structures as well as electrical components of the portable electronic device. Often, the portable electronic device includes various assemblies that include various structures, such as layered structures. In portable electronic devices, components are placed in confined spaces and compactness is important. Adhesives are often used to assemble components. A Pressure Sensitive Adhesive (PSA) can be used by to assemble components by applying pressure on adjacent parts separated by the PSA. While such assembly is useful, in some conditions a stronger adhesive bond is needed to assemble components. A Temperature Sensitive Adhesive (TSA) offers substantially greater bonding strength than does PSA but requires heating as opposed to pressure to active the adhesive bonding. Unfortunately, however, TSA may not be suitable if the components to be assembled cannot endure the heating required to activate the TSA. Heating of components in a compact environment can also be challenging due to space constraints. Therefore, there remains a continuing need to provide improved techniques and structures for supporting and joining structures for portable electronic device housings.

### SUMMARY

The invention pertains to techniques for optically activating thermally activated adhesives. In one embodiment, a laser can be used to activate thermally activated adhesive. In one implementation, a laser output can be directed through a structural component that is coupled to another structural component through use of thermally activated adhesive. As a result, the structural components to be adhered together can, first, be placed in the appropriate position with the adhesive in a non-active state, and second, a laser can provide the laser output to activate the adhesive (whereby the adhesive transitions from the non-active state to an active state).

The structural components can form an assembly that can be used with compact electronic devices, such as portable electronic devices. The assembly can be achieved with only a thin layer of adhesive. The adhesive can be temperature-activated after the structural components have been placed in position for the assembly.

The invention can be implemented in numerous ways, including as a method, system, device, or apparatus. Several embodiments of the invention are discussed below.

As a method for assembling a structural assembly, one embodiment can, for example, include at least: placing a second structural component adjacent a first structural component with an adhesive therebetween; directing optical energy towards the adhesive through the second structural component, the second structural component being substantially transparent to the optical energy; and activating the adhesive as a result of the optical energy being directed towards the adhesive, the adhesive becomes activated such that the first structural component is bonded to the second structural component via the adhesive.

As a method for forming a structural assembly for a portable electronic device, one embodiment can, for example, include at least: providing a first structural component; providing a second structural component, the second structural component being substantially transparent to optical energy; assembling the first structural component at least partially adjacent to the second structural component with the adhesive layer provided between the first structural component and the second structural component; and activating the adhesive layer using optical energy to induce heating of the adhesive layer and thereby adhere the first structural component at least partially to the second structural component via the adhesive layer.

As consumer electronic device, one embodiment can, for example, include at least one structural assembly. The at least one structural assembly including at least: a first structural element, a second structural element, and an adhesive layer interposed between at least a portion of the first structural element and the second structural element. The adhesive layer can include a temperature activated adhesive that was previously activated using laser energy applied to the adhesive layer via the second structural element, and wherein the second structural element is substantially transparent to the laser energy.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a flow diagram of an adhesive activation process according to one embodiment.

FIGS. 2A-2C illustrate assembly of a structural member according to one embodiment.

FIG. 3 illustrates a structural member according to one embodiment.

FIG. 4 is a flow diagram of an adhesive activation process according to one embodiment.

FIGS. 5A-5C illustrate assembly of an outer housing members as one structural component with a protective side member as another structural component.

FIGS. 6A and 6B are diagrammatic representations of electronic device according to one embodiment.

FIGS. 7A and 7B are diagrammatic representations of electronic device according to another embodiment.

### DETAILED DESCRIPTION OF EMBODIMENTS OF THE INVENTION

The invention pertains to techniques for optically activating thermally activated adhesives. In one embodiment, a laser can be used to activate thermally activated adhesive. In one implementation, a laser output can be directed through a structural component that is coupled to another structural component through use of thermally activated adhesive. As a result, the structural components to be adhered together can, first, be placed in the appropriate position with the adhesive in a non-active state, and second, a laser can provide the laser output to activate the adhesive (whereby the adhesive transitions from the non-active state to an active state).

The structural components being assembled can, for example, pertain to compact electronic devices, such as portable electronic devices. The assembly of the structural components, which can be similar or dissimilar materials, can be achieved with only a thin layer of adhesive. The adhesive can be temperature-activated once the structural components are placed in position for the assembly.

The following detailed description is illustrative only, and is not intended to be in any way limiting. Other embodiments will readily suggest themselves to skilled persons having the benefit of this disclosure. Reference will now be made in detail to implementations as illustrated in the accompanying drawings. The same reference indicators will generally be used throughout the drawings and the following detailed description to refer to the same or like parts. It should be appreciated that the drawings are generally not drawn to scale, and at least some features of the drawings have been exaggerated for ease of illustration.

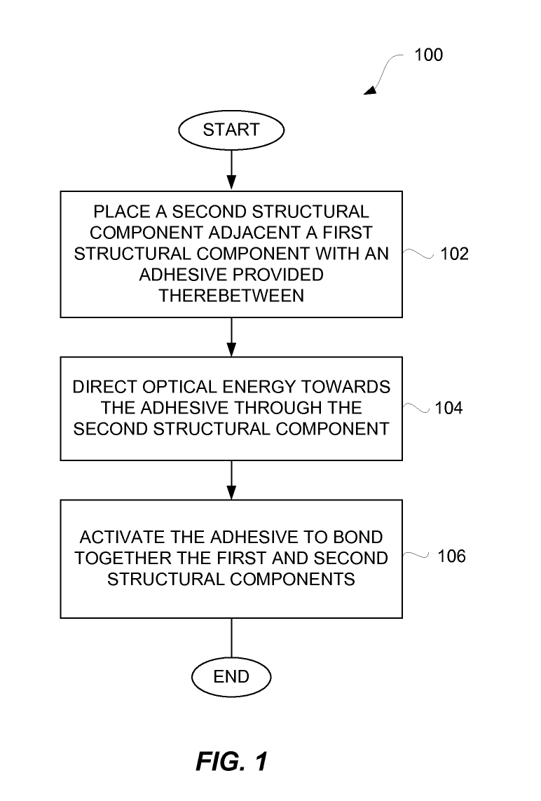

Embodiments are discussed below with reference to FIGS. 1-7B. However, those skilled in the art will readily appreciate that the detailed description given herein with respect to these figures is for explanatory purposes as the invention extends beyond these limited embodiments.

Typically, activation of adhesives, namely, temperature activated adhesives, is done with physical contact with a heating source. However, with respect to smaller compact devices components are small and often not suitable for being heated by a heating source. Hence, the techniques and apparatus described herein are particularly suitable for use with smaller compact devices.

FIG. 1 is a flow diagram of an adhesive activation process 100 according to one embodiment. The adhesive activation process 100 is a process that can be used in the manufacture or assembly of structural components for any of a variety of different purposes. Typically, activation of adhesives, namely, temperature activated adhesives, is done by physical contact with a heating source. However, with respect to small compact devices, the components are small and often not well suited for being heated by a heating source. Hence, the adhesive activation process 100 described herein is particularly suitable for use with small compact devices, such as portable electronic devices.

The adhesive activation process 100 can initially place 102 a second structural component adjacent to a first structural component with an adhesive provided between the first and second structural components. The adhesive can be applied to one or both of the adjacent surfaces of the first and second structural component to be combined. Alternatively, the adhesive can be merely positioned between the adjacent surfaces of the first and second structural components. At this point, the first and second structural components are placed 102 in their desired position relative to one another and the adhesive, in a non-activated state, is provided therebetween. In this embodiment, the adhesive is a temperature activated adhesive that remains in a non-activated state until heated sufficiently.

Next, optical energy can be directed 104 towards the adhesive through the second structural component. Here, optical energy, such as electromagnetic radiation provided by a laser, can be used to activate the initially non-active adhesive. The optical energy is used to heat the temperature activated adhesive. Thereafter, following sufficient heating by the optical energy, the adhesive, i.e., temperature activated adhesive, is activated 106 and thereby serves to bond together the first and second structural components.

As noted above, the adhesive can be temperature activated adhesive, which can activate upon being heated to a particular activation temperature. More specifically, the optical energy provided by the laser can be directed towards the adhesive so as to heat the adhesive and thus cause the adhesive to activate. The heating is thus localized to the adhesive such that the components need not be heated to the activation temperature. After the adhesive has been activated 106, the first and second structural components are bonded together by way of the adhesive which is now activated. Following the block 106, the adhesive activation process 100 is complete and ends.

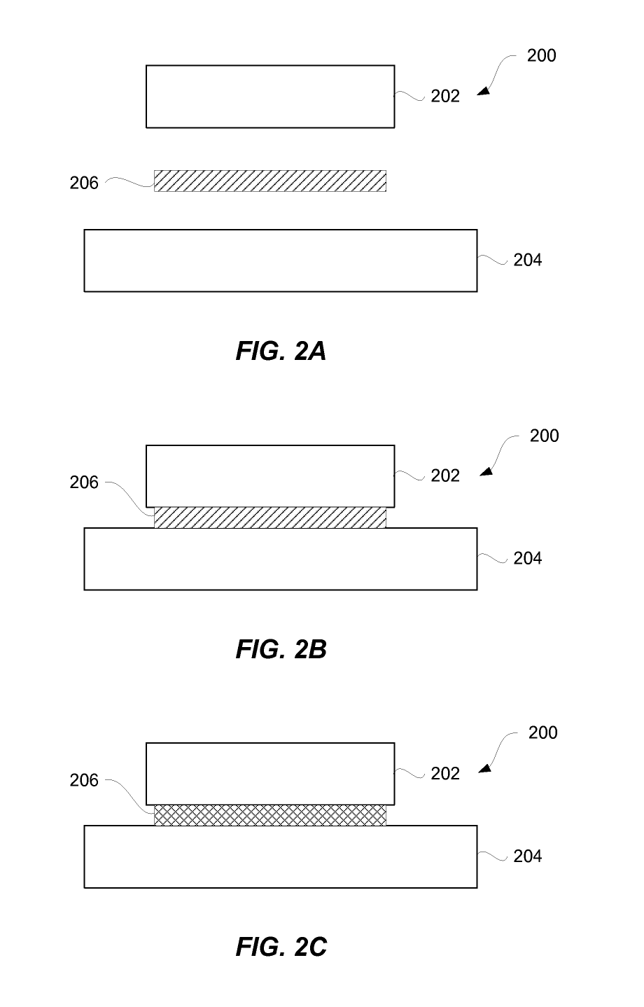

FIGS. 2A-2C illustrate assembly of a structural member 200 according to one embodiment. The structural member 200 as shown in FIG. 2A is shown disassembled. The structural member 200 is a structure that results from a first structural component 202 and a second structural component 204 which are assembled using an adhesive 206. The adhesive 206 can be provided as a quantity or layer of adhesive. The adhesive 206 is a temperature activated adhesive that is initially in its non-activated state. Next, as shown in FIG. 2B, the structural member 200 can be arranged in its desired configuration. As shown in FIG. 2B, the desired configuration has the first structural component 202 positioned adjacent the second structural component 204 with the adhesive 206 positioned between the adjacent surfaces of the first structural component 202 and the second structural component 204.

Thereafter, as shown in FIG. 2C, following activation of the adhesive 206 through heating the adhesive, the adhesive 206 becomes activated and thereby serves to bond together the first structural component 202 and the second structural component 204.

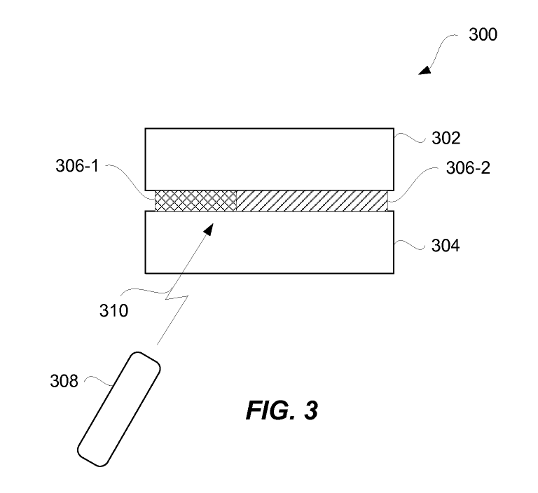

FIG. 3 illustrates a structural member 300 according to one embodiment. The structural member 300 includes a first structural component 302 and a second structural component 304. The first and second structural components 302 and 304 are assembled together. An adhesive 306 is provided between a pair of adjacent surfaces of the first and second structural components 302 and 304. In one implementation, the adhesive 306 is a layer (or film) of temperature activated adhesive.

A radiation source 308, such as a laser, can produce optical energy 310, such as electromagnetic radiation, that can be directed towards the adhesive 306 through the second structural component 304. For example, the laser can be a CO₂ laser or an infrared laser. Since the optical energy is directed through the second structural component 304, the second structural component 304 should be substantially transparent to the optical energy 310. In such case, the optical energy 302 can pass through the second structural component 304 without being significantly altered or absorbed and thus can reach the adhesive 306. The optical energy serves to heat the adhesive 306. With adequate heating, the adhesive can transition from a non-active state to an active state.

In the example illustrated in FIG. 3, the adhesive 306 is shown midway through the activation process. In this regard, the adhesive 306 has a first portion of adhesive 306-1 that has been activated by the optical energy 310 supplied by the radiation source 308. In other words, the optical energy 306 has been applied to the first portion of adhesive 306-1 such that its temperature has increased beyond the minimum activation temperature. However, a second portion of adhesive 306-2 has not yet been activated by the optical energy 310 so it remains in the non-activated state.

Advantageously, the optical energy 310 is able to be used to locally heat the adhesive without needed to heat either of the components 302, 304 being assembled and without the need for component material to necessarily withstand temperatures at or beyond the minimum activation temperature. The activation is thus localized primarily at the adhesive 306 which makes the heating and activation efficient. The components can support the localized heating but need not be fully heated when activating the adhesive 306.

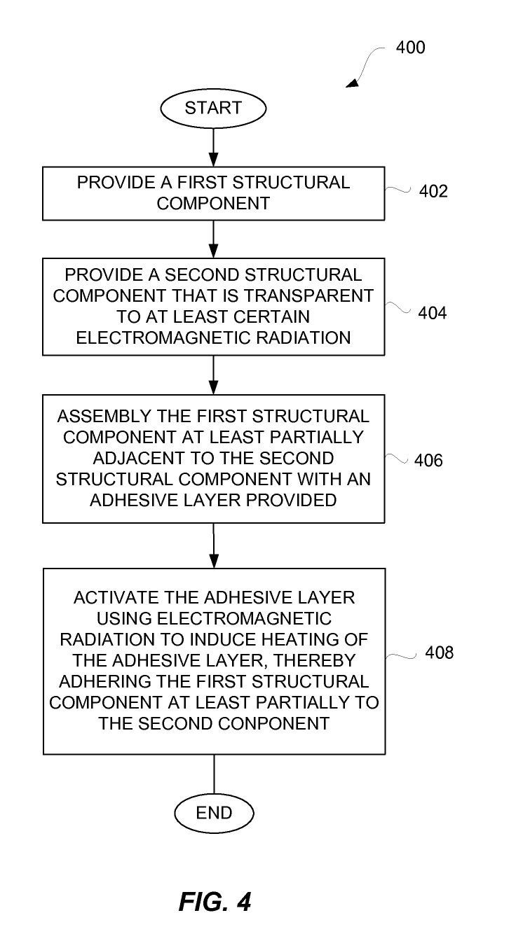

FIG. 4 is a flow diagram of an adhesive activation process 400 according to one embodiment of the invention. The adhesive activation process 400 is, for example, suitable for activating adhesive that is utilized to form an assembly of one or more structural components. In particular, as illustrated in FIG. 4, the adhesive activation process 400 can provide 402 a first structural component, and can provide 404 a second structural component. The second structural component is substantially transparent to a least certain electromagnetic radiation.

Next, the first structural component can be assembled 406 (or arranged) to the second structural component such that the first structural component is at least partially adjacent to the second structural component. An adhesive layer can also be provided between one or more locations between the adjacent surfaces of the first and second structural components. Once assembled 406, the adhesive layer can be activated 408 using electromagnetic radiation. The electromagnetic radiation can induce heating of the adhesive layer. When, by heating the adhesive layer, the temperature of the adhesive layer exceeds the thermal transition temperature to activate the adhesive, the adhesive becomes activated and thereby adheres together the first structural component at least partially to the second structural component. Thereafter, the electromagnetic radiation can cease, the structural assembly can cool down and the adhesive layer, now activated, can serve to secure together the first and second structural components. Following the block 408, the adhesive activation process 400 can end.

As discussed above, structural components can be assembled using optical energy to activate temperature activated adhesive. The structural components can be internal or external components of an electronic device. In one embodiment, at least one of the structural components can pertain to a portion of a housing of an electronic device. For example, the at least one of the structural components can provide an outer surface for the housing of the electronic device. In another embodiment, the structural components are internal to a housing of an electronic device.

The structural components can be formed from any of a variety of materials, such as glass, polymers, or metal. Typically, however, one of the components is substantially transparent to the optical energy being applied to activate an adhesive that is used to bond the structural components together. For example, if the optical energy is infrared radiation, at least one of the structural components is substantially transparent to infrared radiation, such as glass or polymers. Such structural component, however, need not necessarily be optically translucent or clear. The other structural component(s) to be adhered to the structural component that is substantially transparent to infrared radiation can be a similar material or a dissimilar material. As one example, if both structural components are glass or both structural components are polymers, the structural components are similar to one another. As another example, if one structural component is glass and another structural component is metal, the structural components are dissimilar to one another.

Given that the structural assemblies are for electronic devices, and often compact electronic devices, the structural components tend to be rather small. For example, a structural component is typically thin, particularly when used with portable electronic devices, such as on the order of thickness of less than 5 mm, or in some cases less than 1 mm. The use of optical energy enables the activation of adhesive without having to physically contact the components or without having to necessarily heat either the components to an activation temperature. As a result, since heating through optical energy, the heating can be performed locally at the temperature sensitive adhesive. As a result, heating of the components to activate the adhesive is substantially reduced. Also, by the use of optical energy, the heating can occur without physical contact which can be useful for confined spaced, small scale components or material that are not to be heated to the activation temperature.

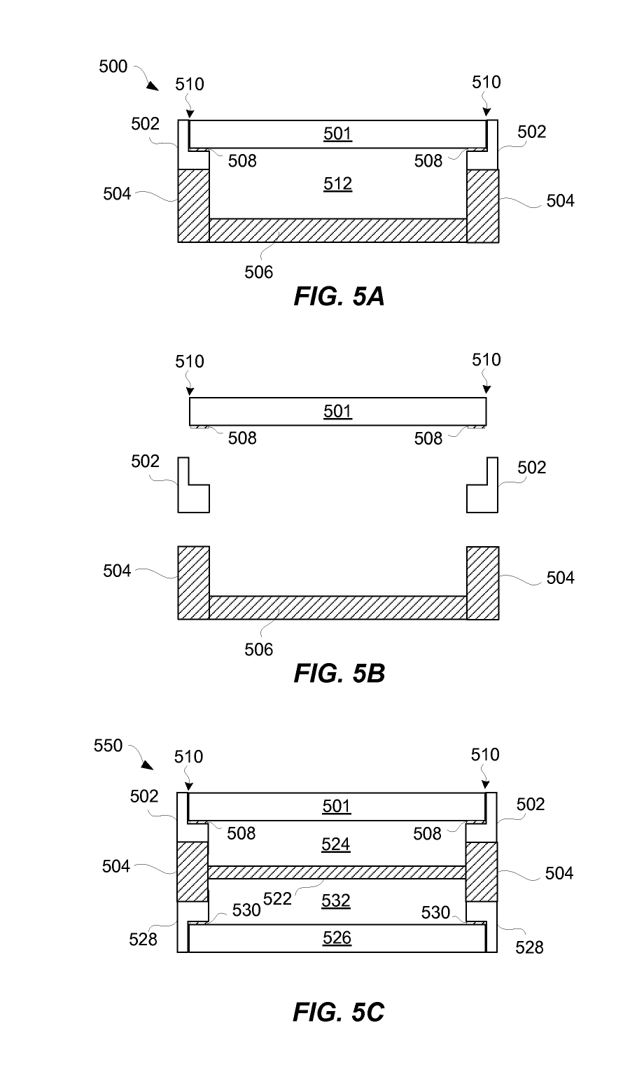

In any case, the electronic device including the structural assembly can be a portable electronic device. The structural assembly can pertain to internal and/or external components. FIGS. 5A-5C illustrate assembly of an outer housing member as one structural component with a protective side member as another structural component.

FIG. 5A is a cross-sectional view of an electronic device housing 500 according to one embodiment. The electronic device housing 500 includes an outer housing member 501 supported and protected by a protective side member 502. The protective side member 502 being positioned tightly adjacent sides of the outer housing member 501. The protective side members 502 can provide a thin layer of material positioned tightly adjacent sides of the outer housing member 501, thereby buffering impact at the sides of the outer housing member 501. The protective side member 502 can also support the outer housing member 501 and can serve to secure the outer housing member 501 to other portions of the electronic device housing 500. In one embodiment, the protective side member 502 extends around all sides of the outer housing member 501. In another embodiment, the protective side member 502 extends around those of the sides of the outer housing member 501 that would otherwise be exposed.

As shown in FIG. 5A, the outer housing member 501 can be secured to a support structure 504 of the electronic device housing 500. The support structure 504 can, for example, be an outer periphery member for the electronic device housing 500. In one embodiment, the support structure 504 can couple to another outer housing member 506, which can be formed differently than the outer housing member 501.

The protective side member 502 can be secured tightly adjacent the sides of the outer housing member 501 using an adhesive 508. In one embodiment, the adhesive 508 can be applied as a layer of adhesive that is provided around a periphery of an inner side of the outer housing member 501. The adhesive 508 can thus serve to secure the protective side member 502 against the sides of the outer housing member 501. Also, the adhesive 508 is typically a temperature activated adhesive which, once activated, can form a strong bond between the outer housing member 501 and the peripheral protective side member 502 via the adhesive 508. The temperature of the adhesive 508 is activated to an activation temperature using optical energy directed to the adhesive 508 through the outer housing member 501. An internal space 512 is provided internal to the electronic device housing 500 whereby various electrical components can be attached, affixed or placed so as to provide electronic operations for the electronic device.

The various members, parts or assemblies of the electronic device housing 500 can be formed of any of a variety of materials, e.g., glass, polymers or metal. In one embodiment, the outer housing member 501 is glass, the protective side member 502 is be formed from polymer (e.g., thermoplastic), the support structure 504 is formed from metal or polymer (e.g., plastic), and the another outer housing member 506 is formed from glass, polymer (e.g., plastic) or metal. More particularly, in some embodiments, the protective side member 502 can be a structurally strengthened polymer (e.g., thermoplastic). As an example, the protective side member 502 can be a polymer, such as polyarylamide, nylon or polycarbonate, which can be structurally strengthened by including glass fibers. For example, some examples of some structurally strengthened polymers include 50% glass filled nylon and 30% glass filled polycarbonate.

FIG. 5B is a cross-sectional assembly diagram for the electronic device housing 500 shown in FIG. 5A, according to one embodiment. The outer housing member 501 has a top surface 514 and a bottom surface 516. The bottom surface 516 of the outer housing member 501 has adhesive 508 applied as a layer of adhesive that is provided around a periphery of the bottom surface 516 of the outer housing member 501. The protective side member 502 can then be placed or formed adjacent the sides of the outer housing member 501. Moreover, the protective side member 502 can also be adjacent and secured to an upper side portion 518 of the support structure 504. When the protective side member 502 are provided at the sides (i.e., edges) of the outer housing member 501, the protective side member 502 provides a buffer layer (e.g., bumper) that dampens impact induced at the sides of the outer housing member 501 of the electronic device housing 500.

FIG. 5C is a cross-sectional view of an electronic device housing 520 according to one embodiment. The electronic device housing 520 includes a first outer housing member 501 supported and protected by a first protective side member 502. The first protective side member 502 is positioned tightly adjacent sides of the first outer housing member 501. The first protective side member 502 also supports the first outer housing member 501 and serves to secure the first outer housing member 501 to other portions of the electronic device housing 520. In this embodiment, the first protective side member 502 is secured to not only the first outer housing member 501 but also a support structure 504. The support structure 504 may be an outer periphery member for the electronic device housing 520.

The first protective side member 502 can be secured tightly adjacent the sides of the outer housing member 501 using the adhesive 508. In one embodiment, the adhesive 508 can be applied as a layer of adhesive that is provided around a periphery of an inner side of the first outer housing member 501. The adhesive 508 can thus serve to secure the first protective side member 502 against the sides of the first outer housing member 501. Also, the adhesive 508 is typically a temperature activated adhesive which, once activated, can form a strong bond between the first outer housing member 501 and the first protective side member 502 via the adhesive 508. The temperature of the adhesive 508 is activated to an activation temperature using optical energy directed to the adhesive 508 through the first outer housing member 501.

The electronic device housing 520 can also include an internal structure 522 that is integral with or secured to the support structure 504. In one embodiment, the internal structure 522 can be secured to an inner surface of the support structure 504 such that it is offset from front and back planar boundaries of the support structure 504 (which may be an outer periphery member). As shown in FIG. 5C, the internal structure 522 can be secured at the mid-point of the height of the support structure 504. A first internal space 524 is provided internal to the electronic device housing 520 whereby various electrical components can be attached, affixed or placed so as to provide electronic operations for the electronic device.

In this embodiment, the electronic device housing 520 can also include similar structures on an opposite side of the electronic device housing 520. Namely, the electronic device housing 520 can further include a second outer housing member 526 supported and protected by a second protective side member 528. The second protective side member 528 can be positioned tightly adjacent sides of the second outer housing member 526. The second protective side member 528 also supports the second outer housing member 526 and serves to secure the second outer housing member 526 to other portions of the electronic device housing 520. In this embodiment, the second protective side member 528 is secured to not only the second outer housing member 526 but also the support structure 504. As previously noted, the support structure 504 may be an outer periphery member for the electronic device housing 520. In this embodiment, the second protective side member 528 can be secured to the outer periphery member 504 on the opposite side from the first protective side member 502. The second protective side member 528 can be secured tightly adjacent the sides of the second outer housing member 526 using an adhesive 330. In one embodiment, the adhesive 330 can be applied as a layer of adhesive that is provided around a periphery of an inner side of the second outer housing member 526. The second protective side member 528 can also placed or formed so as to be tightly adjacent the sides of the second outer housing member 526. Further, a second internal space 532 is provided internal to the electronic device housing 520 (between the internal structure 522 and the second outer housing member 526) whereby various electrical components can be attached, affixed or placed so as to provide electronic operations for the electronic device. The second internal space 530 can be separate from or joined with the first internal space 524.

In one embodiment, the first outer housing member 501 can represent a top outer surface for the portable electronic device, and the second outer surface housing 526 can represent a bottom outer surface housing. In one embodiment, both the first outer housing member 501 and the second outer housing member 526 are glass (e.g., glass covers).

As previously discussed, the components being assembled can represent portions of a housing for electronic devices, such as portable electronic devices. Those portable electronic devices that are small and highly portable can be referred to as handheld electronic devices. A handheld electronic device may, for example, function as a media player, phone, internet browser, email unit or some combination of two or more of such. A handheld electronic device generally includes a housing and a display area.

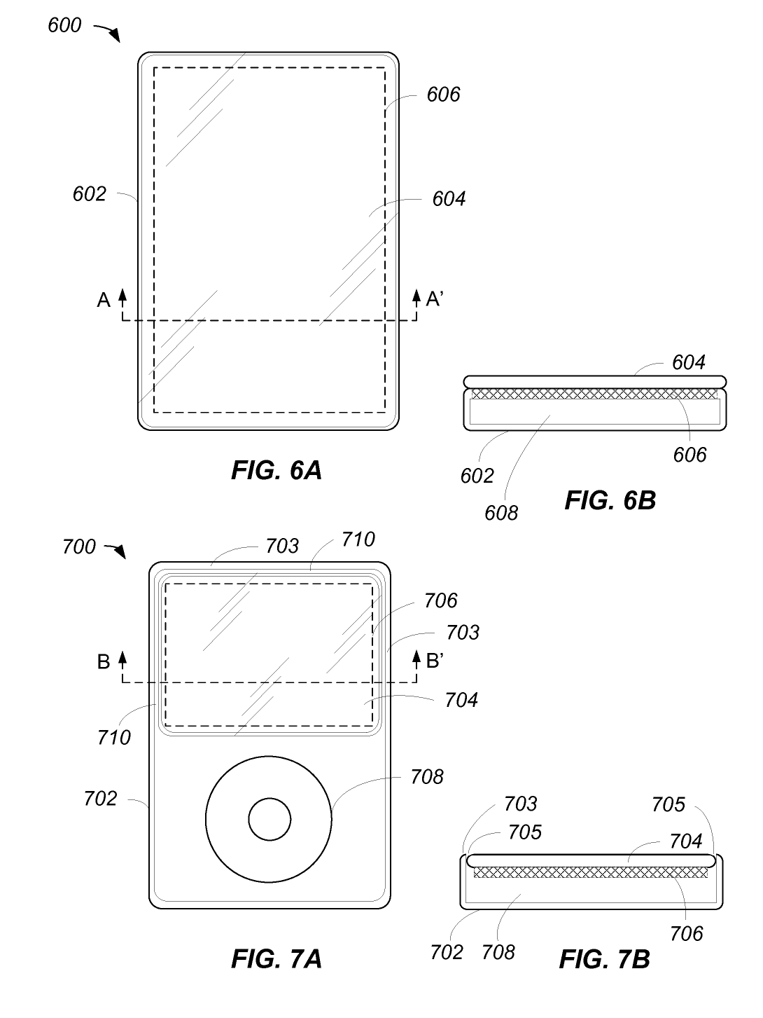

FIGS. 6A and 6B are diagrammatic representations of electronic device 600 according to one embodiment. FIG. 6A illustrates a top view for the electronic device 600, and FIG. 6B illustrates a cross-sectional side view for electronic device 600 with respect to reference line A-A′. Electronic device 600 can include housing 602 that has cover window 604 (e.g., glass or plastic cover) as a top surface. Cover window 604 is primarily transparent so that display assembly 606 is visible through cover window 604. Display assembly 606 can, for example, be positioned adjacent cover window 604. Housing 602 can also contain internal electrical components besides the display assembly, such as a controller (processor), memory, communications circuitry, etc. Display assembly 606 can, for example, include a LCD module. By way of example, display assembly 606 may include a Liquid Crystal Display (LCD) that includes a Liquid Crystal Module (LCM). In one embodiment, cover window 604 can be integrally formed with the LCM. Housing 602 can also include an opening 608 for containing the internal electrical components to provide electronic device 600 with electronic capabilities. In one embodiment, housing 602 may need not include a bezel for cover window 604. Instead, cover window 604 can extend across the top surface of housing 602 such that the edges of cover window 604 can be aligned (or substantially aligned) with the sides of housing 602. The edges of cover window 604 can remain exposed. Although the edges of cover window 604 can be exposed as shown in FIGS. 6A and 6B, in alternative embodiment, the edges can be further protected. As one example, the edges of cover window 604 can be recessed (horizontally or vertically) from the outer sides of housing 602. As another example, the edges of cover window 604 can be protected by additional material placed around or adjacent the edges of cover window 604.

Cover window 604 may generally be arranged or embodied in a variety of ways. By way of example, cover window 604 may be configured as a protective translucent piece that is positioned over an underlying display (e.g., display assembly 606) such as a flat panel display (e.g., LCD) or touch screen display (e.g., LCD and a touch layer). Alternatively, cover window 604 may effectively be integrated with a display, i.e., a translucent window may be formed as at least a portion of a display. Additionally, cover window 604 may be substantially integrated with a touch sensing device such as a touch layer associated with a touch screen. In some cases, cover window 604 can serve as the outer most layer of the display.

FIGS. 7A and 7B are diagrammatic representations of electronic device 700 according to another embodiment. FIG. 7A illustrates a top view for electronic device 700, and FIG. 7B illustrates a cross-sectional side view for electronic device 700 with respect to reference line B-B′. Electronic device 700 can include housing 702 that has cover window 704 (e.g., glass or plastic cover) as a top surface. In this embodiment, cover window 704 can be protected by side surfaces 703 of housing 702. Here, cover window 704 does not fully extend across the top surface of housing 702; however, the top surface of side surfaces 703 can be adjacent to and aligned vertically with the outer surface of cover window 704. Since the edges of cover window 704 can be rounded for enhanced strength, there may be gaps 705 that are present between side surfaces 703 and the peripheral edges of cover window 704. Gaps 705 are typically very small given that the thickness of cover window 704 is thin (e.g., less than 3 mm). However, if desired, gaps 705 can be filled by a material. The material can be plastic, rubber, metal, etc. The material can conform in gap 705 to render the entire front surface of electronic device 700 flush, even across gaps 705 proximate the peripheral edges of cover window 704. The material filling gaps 705 can be compliant. The material placed in gaps 705 can implement a gasket. By filling the gaps 705, otherwise probably undesired gaps in the housing 702 can be filled or sealed to prevent contamination (e.g., dirt, water) forming in the gaps 705. Although side surfaces 703 can be integral with housing 702, side surface 703 could alternatively be separate from housing 702 and, for example, operate as a bezel for cover window 704.

Cover window 704 is primarily transparent so that display assembly 706 is visible through cover window 704. Display assembly 706 can, for example, be positioned adjacent cover window 704. Housing 702 can also contain internal electrical components besides the display assembly, such as a controller (processor), memory, communications circuitry, etc. Display assembly 706 can, for example, include a LCD module. By way of example, display assembly 706 may include a Liquid Crystal Display (LCD) that includes a Liquid Crystal Module (LCM). In one embodiment, cover window 704 is integrally formed with the LCM. Housing 702 can also include an opening 708 for containing the internal electrical components to provide electronic device 700 with electronic capabilities.

The front surface of electronic device 700 can also include user interface control 708 (e.g., click wheel control). In this embodiment, cover window 704 does not cover the entire front surface of electronic device 700. Electronic device 700 essentially includes a partial display area that covers a portion of the front surface.

Cover window 704 may generally be arranged or embodied in a variety of ways. By way of example, cover window 704 may be configured as a protective translucent piece that is positioned over an underlying display (e.g., display assembly 706) such as a flat panel display (e.g., LCD) or touch screen display (e.g., LCD and a touch layer). Alternatively, cover window 704 may effectively be integrated with a display, i.e., a translucent window may be formed as at least a portion of a display. Additionally, cover window 704 may be substantially integrated with a touch sensing device such as a touch layer associated with a touch screen. In some cases, cover window 704 can serve as the outer most layer of the display.

The assembly techniques describe herein may be applied to assemble structural components used by any of a variety of electronic devices including but not limited handheld electronic devices, portable electronic devices and substantially stationary electronic devices. Examples of these include any known consumer electronic device that includes a display. By way of example, and not by way of limitation, the electronic device may correspond to media players, mobile phones (e.g., cellular phones), PDAs, remote controls, notebooks, tablet PCs, monitors, all in one computers and the like.

The various aspects, features, embodiments or implementations of the invention described above can be used alone or in various combinations.

Additional details on side protective members for electronic device housings are contained in: (1) U.S. application Ser. No. 12/794,563, filed Jun. 4, 2010, and entitled “OFFSET CONTROL FOR ASSEMBLYING AN ELECTRONIC DEVICE HOUSING,” which is hereby incorporated herein by reference; and (2) U.S. application Ser. No. 12/944,671, filed Nov. 11, 2010, and entitled “INSERT MOLDING AROUND GLASS MEMBERS FOR PORTABLE ELECTRONIC DEVICES,” which is hereby incorporated herein by reference.

In general, the steps associated with the methods of the present invention may vary widely. Steps may be added, removed, altered, combined, and reordered without departing from the spirit or the scope of the present invention.

The various aspects, features, embodiments or implementations of the invention described above may be used alone or in various combinations.

While this specification contains many specifics, these should not be construed as limitations on the scope of the disclosure or of what may be claimed, but rather as descriptions of features specific to particular embodiment of the disclosure. Certain features that are described in the context of separate embodiments may also be implemented in combination. Conversely, various features that are described in the context of a single embodiment may also be implemented in multiple embodiments separately or in any suitable subcombination. Moreover, although features may be described above as acting in certain combinations, one or more features from a claimed combination can in some cases be excised from the combination, and the claimed combination may be directed to a subcombination or variation of a subcombination.

While embodiments and applications have been shown and described, it would be apparent to those skilled in the art having the benefit of this disclosure that many more modifications than mentioned above are possible without departing from the inventive concepts herein.

What is claimed is:

1. A method for assembling a structural assembly, comprising:
placing a second structural component adjacent a first structural component with an adhesive therebetween;
directing optical energy towards the adhesive through the second structural component, the second structural component being substantially transparent to the optical energy; and
activating the adhesive as a result of the optical energy being directed towards the adhesive, the adhesive becomes activated such that the first structural component is bonded to the second structural component via the adhesive.

2. A method as recited in claim 1, wherein the directing of the optical energy towards the adhesive induces heating of the adhesive.

3. A method as recited in claim 2, wherein the heating of the adhesive transitions the adhesive from a non-active state to an activated state.

4. A method as recited in claim 1, wherein the optical energy is infrared energy.

5. A method as recited in claim 4, wherein an infrared laser provides the infrared energy that is used to active the adhesive through the second structural component.

6. A method as recited in claim 1, wherein the second structural component comprises glass.

7. A method as recited in claim 1, wherein the second structural component comprises at least one polymer.

8. A method as recited in claim 1, wherein the structural assembly forms a part of a portable electronic device.

9. A method as recited in claim 8, wherein the part of the housing comprises a LCD module.

10. A method as recited in claim 1, wherein the adhesive has a thickness in the range of about 30-100 microns.

11. A method for forming a structural assembly for a portable electronic device, the method comprising:
providing a first structural component;
providing a second structural component;
assembling the first structural component at least partially adjacent to the second structural component with the adhesive layer provided between the first structural component and the second structural component; and
activating the adhesive layer using optical energy to induce localized heating of the adhesive layer and thereby adhere the first structural component at least partially to the second structural component via the adhesive layer.

12. A method as recited in claim 11, wherein the activating comprises:
directing the optical energy towards the adhesive layer via the second structural component,
wherein the second structural component being substantially transparent to optical energy.

13. A method as recited in claim 11, wherein the activating comprises:
providing a laser to provide the optical energy; and
directing the optical energy towards the adhesive layer through the second structural component.

14. A consumer electronic device, comprising:
at least one structural assembly, the at least one structural assembly including at least:
a first structural element,
a second structural element, and
an adhesive layer interposed between at least a portion of the first structural element and the second structural element,
wherein the adhesive layer comprises a temperature activated adhesive that was previously activated using laser energy applied to the adhesive layer via the second structural element, and wherein the second structural element is substantially transparent to the laser energy.

15. A consumer electronic device as recited in claim 14, wherein the second structural element comprises polymer or glass.

16. A consumer electronic device as recited in claim 14, wherein the laser energy is infrared energy.

17. A consumer electronic device as recited in claim 14, wherein the at least one structural assembly corresponds to at least a portion of a housing for the consumer electronic device.

18. A consumer electronic device as recited in claim 14, wherein the portion of the housing comprises a LCD module.

19. A consumer electronic device as recited in claim 14, wherein the adhesive layer has a thickness in the range of about 30-100 microns.

20. A consumer electronic device as recited in claim 14, wherein the laser energy is provided by a CO₂ laser.

21. A consumer electronic device as recited in claim 14, wherein the laser energy is provided by an infrared laser.
